(19) United States
(12) Patent Application Publication
(10) Pub. No.: US 2014/0028241 A1
(43) Pub. Date: Jan. 30, 2014

(54) SELF-CONTAINED OFF-GRID SOLAR PANEL/GENERATOR

(71) Applicant: Mark M. Hixson, Hixson, TN (US)

(72) Inventor: Mark M. Hixson, Hixson, TN (US)

(21) Appl. No.: 13/911,730

(22) Filed: Jun. 6, 2013

Related U.S. Application Data
(60) Provisional application No. 61/656,027, filed on Jun. 6, 2012.

(51) Int. Cl. H02J 7/35; H02J 7/02

(52) U.S. Cl. CPC H02J 7/35; H02J 7/025
USPC 320/101

(57) ABSTRACT

A portable self-contained off-grid solar panel/generator is disclosed. The self-contained off-grid solar panel/generator is configured for power generation for tools, cooking equipment, electric machines, electronic devices, and the like. The self-contained off-grid solar panel/generator is useful in locations where traditional power sources are not available or reliable, such as campsites, worksites, picnic sites, county or state fairgrounds, craft shows, festivals, the desert, parks, athletic events, parking lots, and the like. In at least one embodiment, the self-contained off-grid solar panel/generator includes solar panels, at least one storage battery, an inverter, and a charge controller, all self-contained within the solar generator system.

### CROSS-REFERENCE TO RELATED APPLICATION(S)

The present non-provisional patent application claims the benefit of priority of U.S. Provisional Patent Application No. 61/656,027, which is entitled “SELF-CONTAINED OFF-GRID SOLAR PANEL/GENERATOR”, which was filed on Jun. 6, 2012, and which is incorporated in full by reference herein.

### FIELD OF THE INVENTION

The technology described herein relates generally to the fields of alternative power sources, solar energy collection systems, solar electric generator, mobile solar energy power sources, solar panels, photovoltaic cells to produce electricity, inverters, batteries, and charge controllers. More specifically, this technology relates to a portable self-contained off-grid solar panel/generator having self-contained solar panels, at least one storage battery, an inverter, and a charge controller, all self-contained within the solar generator system and/or all contained within a self-contained solar panel system.

### BACKGROUND OF THE INVENTION

Solar panels are utilized to provide alternative power sources to power consuming devices. Solar power is useful in locations where traditional power sources are not available or reliable, such as campsites, worksites, picnic sites, county or state fairgrounds, craft shows, festivals, the desert, parks, athletic events, parking lots, and the like. By way of example, tools, cooking equipment, electric machines, electronic devices, and the like, all can be powered by traditional power sources. However, alternative power sources would enable use in remote locations or where traditional power is not reliable. Furthermore, alternative power sources can be used purposefully to avoid use of traditional power systems even when it is available.

Related utility patents known in the art include the following:

U.S. Pat. No. 4,421,943, issued to Withjack on Dec. 20, 1983, discloses a collapsible mobile solar energy power source. An apparatus for collecting solar energy and converting it to electrical energy utilizing solar panels pivotally mounted to a base such that the panels may be pivoted to a storage position inside said base is disclosed. Additional solar panels may be pivotally mounted on retractable frame trays which stow inside the base when the panels are pivoted to a horizontal position.

U.S. Pat. No. 5,969,501, issued to Glidden et al. on Oct. 19, 1999, discloses a portable solar power system. A trailer mounted, self contained solar power system having a plurality of solar panel sections that are arranged to fold about the sides and top of the trailer is disclosed. The panel sections unfold and lock together through slide rams that are contained within a rack structure supporting the panel sections to form a planar array that is easily deployable at a desired angle to the horizontal. The planar array pivots about a hinge along one side of the trailer top, and the panel sections are asymmetrically arranged so that positioning of the planar array can be easily accomplished.

U.S. Pat. No. 7,492,120, issued to Benn et al. on Feb. 17, 2009, discloses a mobile solar generator. A portable PV modular solar generator for providing electricity to a stationary electrically powered device is disclosed. A plurality of wheels is attached to a rechargeable battery container. The plurality of wheels allows for movement of the PV modular solar generator so that the distance can be varied between the PV modular solar generator can be positioned in optimum sunlight. There is a rechargeable battery contained inside the rechargeable battery container. There is a pivotally connected photovoltaic panel for generating electricity. There is an electrical component for receiving a processing electricity generated by the pivotally connected photovoltaic panel. The electrical component also directs the electricity to either the rechargeable battery for storage or to the stationary electrically powered device. The PV modular solar generator supplies energy to an AC main panel for the stationary electrically powered device. The AC main panel receives generated energy from a public utility grid. The PV modular solar generator also includes a computer for monitoring the status of the public utility grid. The computer is capable of disconnecting the public utility grid from the AC main panel when the public utility grid is not energized and computer is also capable of connecting the public utility grid to the AC main panel when the public utility grid is energized.

U.S. Pat. No. 7,898,212, issued to Benn et al. on Feb. 17, 2009, discloses a portable solar generator. A portable PV modular solar generator is disclosed. A plurality of wheels is attached to the bottom of a rechargeable battery container. At least one rechargeable battery is contained inside the rechargeable battery container. A power conditioning panel is connected to the rechargeable battery container. At least one photovoltaic panel is pivotally connected. In a preferred embodiment, the rechargeable battery container is a waterproof battery enclosure having a knife switch connection. A mast having a rotation bar is supported by the waterproof battery enclosure. At least one solar panel support brace for supporting the photovoltaic panel is attached to the rotation bar. The power conditioning panel is waterproof, is attached to the mast and has a door. When the door is opened, at least one safety switch is opened, breaking an electric circuit. The waterproof power conditioning panel has a charge controller and an inverter. The charge controller is electrically connected to at least one rechargeable battery and at least one photovoltaic panel, and is capable of receiving auxiliary power inputs.

U.S. Pat. No. 8,046,961, issued to Cutting et al. on Nov. 1, 2011, discloses a tactical solar power system. A tactical portable solar control system which can be modular, extremely resistant to destruction, capable of being assembled by a person without instructions, and which creates a small footprint when assembled is disclosed.

The foregoing patent information reflects the state of the art of which the inventors are aware and is tendered with a view toward discharging the inventors' acknowledged duty of candor in disclosing information that may be pertinent to the patentability of the technology described herein. It is respectfully stipulated, however, that the foregoing patent and other information do not teach or render obvious, singly or when considered in combination, the inventors' claimed invention.

### BRIEF SUMMARY OF THE INVENTION

In various exemplary embodiments, the technology described herein provides a portable self-contained off-grid solar panel/generator system. The self-contained off-grid solar panel/generator system is configured for power generation for tools, cooking equipment, electric machines, electronic devices, and the like.

The self-contained off-grid solar panel/generator system can be utilized as a single stand-alone, self-contained solar panel, wherein any other system components are contained within the same solar panel housing.

The self-contained off-grid solar panel/generator system is useful in locations where traditional power sources are not available or reliable, such as campsites, worksites, picnic sites, county or state fairgrounds, craft shows, festivals, the desert, parks, athletic events, parking lots, and the like.

The self-contained off-grid solar panel/generator system is configured for personal use. However, in various embodiments, the self-contained off-grid solar panel/generator system can be used with higher power components and used for commercial or larger power uses.

In one exemplary embodiment, the portable self-contained off-grid solar panel/generator system is configured for utilization in a side-standing position. The side-standing position provides, for example, but not of limitation, at a sixty-five degree angle relative to the ground.

In one exemplary embodiment, the portable self-contained off-grid solar panel/generator system is configured for utilization in a prone position. The prone position provides, for example, but not of limitation, at a twenty degree angle relative to the ground.

In one exemplary embodiment, the portable self-contained off-grid solar panel/generator system includes a solar panel assembly. The solar panel assembly can include one or more solar panels in a solar array.

In one exemplary embodiment, the portable self-contained off-grid solar panel/generator system includes a housing. Within the housing, solar components are stored. The housing can include a door, or opening to the internal area of the housing. The door can be accessed by a door latch. The door latch can be secured, such as using a lock, or being a lock in and of itself.

The portable self-contained off-grid solar panel/generator system is configured for ease of use in transport and set-up. In one exemplary embodiment, the portable self-contained solar generator system includes one or more wheels upon which the system is rolled like a cart.

In at least one embodiment, the portable self-contained off-grid solar panel/generator system includes one or more handles. The handles also provide a user with ease of use in transport and set-up of the portable self-contained solar generator system. The handles can be further configured with grips.

In at least one embodiment, the portable self-contained off-grid solar panel/generator system also includes legs disposed upon the housing. The legs provide a base or rest to the system while it is stationary. In this embodiment, the system loosely resembles a wheel cart or wheel barrow in which the wheel or wheels are in the front of the system and in which when the system is at rest, it is supported by the legs.

In one exemplary embodiment, the self-contained off-grid solar panel/generator system includes an inverter. The inverter is disposed with the housing, but has accessible inputs/outputs such that they are accessible by a user at the outside surface of the housing to the system. The inverter is configured to convert the DC power from the battery or battery bank into AC power for a machine also configured to utilize AC power such as a tool or electric cooking device.

In one exemplary embodiment, the portable self-contained off-grid solar panel/generator system includes a battery or bank of batteries. The battery is configured to store power for supplying power to the tool, electric cooking device, or like device.

In one exemplary embodiment, the portable self-contained off-grid solar panel/generator system includes a charge controller. The charge controller regulates the charge of the battery from power collected by the solar panel or panels.

In various embodiments, the self-contained off-grid solar panel/generator system can also include or more of the following: wiring harnesses, combiners, converters, DC disconnects, grid tie converters, traditional power options, and so forth. In an embodiment having a grid tie converters, the solar kiosk can return power to the traditional power source.

In at least one embodiment, the self-contained off-grid solar panel/generator system also includes a combiner to combine the multiple inputs from the multiple solar panels in the solar panel array.

In various embodiments, the self-contained off-grid solar panel/generator system is configured for outdoor kitchens, workshops, picnic areas, and the like.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a side view of a portable self-contained off-grid solar panel/generator system, illustrating, in particular, a housing assembly and a solar panel assembly, according to an embodiment of the technology described herein;

FIG. 2 is a front perspective view of the portable self-contained off-grid solar panel/generator system depicted in FIG. 1, illustrating, in particular, a solar panel assembly having multiple solar collection cells, according to an embodiment of the technology described herein;

FIG. 3 is a front planar view of the solar panel assembly depicted in FIGS. 1 and 2, illustrating, in particular, a multiplicity of solar voltaic cells, and/or solar panel arrays, according to an embodiment of the technology described herein;

FIG. 4 is a bottom planar view of the portable self-contained off-grid solar panel/generator system depicted in FIG. 1, illustrating, in particular, the housing, housing door, and generator underside, according to an embodiment of the technology described herein;

FIG. 5 is a bottom planar view of the portable self-contained off-grid solar panel/generator system depicted in FIG. 1, illustrating, in particular, the housing, with the housing door removed, an inverter, a charge controller, and a battery, according to an embodiment of the technology described herein;

FIG. 6 is a side planar view of the portable self-contained off-grid solar panel/generator system depicted in FIG. 1, illustrating, in particular, the housing, a housing handle, an inverter, a charge controller, and a battery, according to an embodiment of the technology described herein;

FIG. 7 is a side perspective view of the portable self-contained off-grid solar panel/generator system depicted in FIG. 1, illustrating, in particular, the housing, an inverter, and a charge controller, and shown in a first preferred angle for use to harness the sums rays at the first preferred angle, according to an embodiment of the technology described herein;

FIG. 8 is a side perspective view of the portable self-contained off-grid solar panel/generator system depicted in FIG. 1, illustrating, in particular, the housing, an inverter, and a charge controller, and shown in a second preferred angle for use to harness the sums rays at the second preferred angle, according to an embodiment of the technology described herein;

FIG. 9 is a side perspective view of the portable self-contained off-grid solar panel/generator system depicted in FIG. 1, illustrating, in particular, the housing, with the housing door open, an inverter, a charge controller, and a battery, according to an embodiment of the technology described herein; and

FIG. 10 is a rear perspective view of the portable self-contained off-grid solar panel/generator system r depicted in FIG. 1, illustrating, in particular, the housing, with the housing door open, an inverter, a charge controller, and a battery, according to an embodiment of the technology described herein.

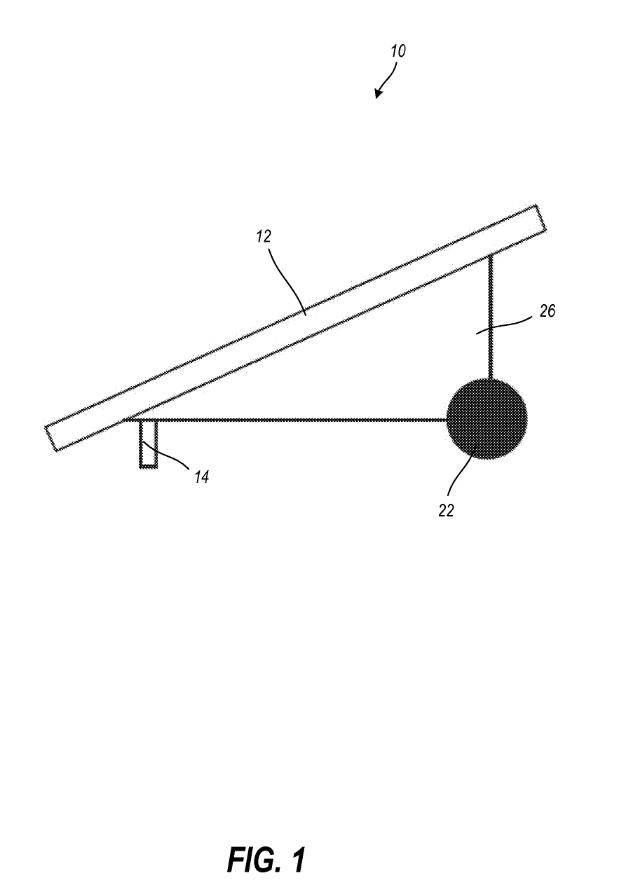

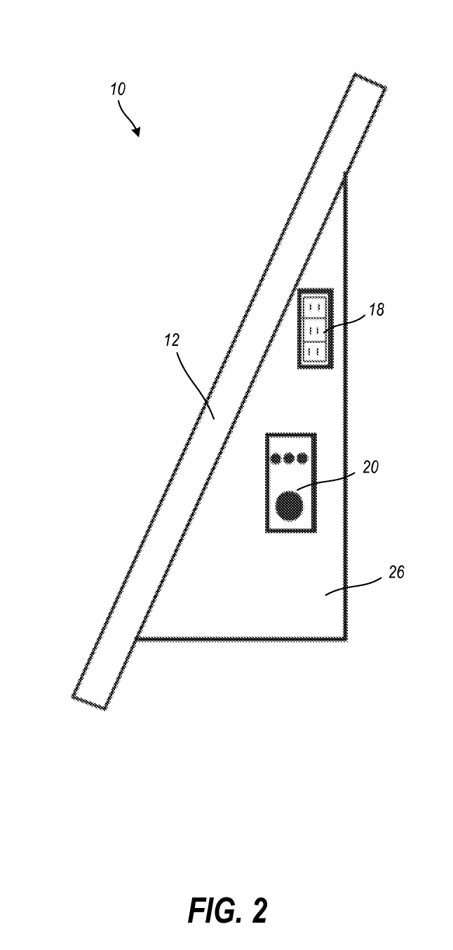

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a portable self-contained off-grid solar panel/generator system 10. The self-contained off-grid solar panel/generator system 10 is configured to provide an alternative power source to tools, cooking equipment, electric machines, electronic devices, and the like. The self-contained off-grid solar panel/generator system 10 can vary in the number of power inputs (solar panels), power stores (batteries), and loads (devices powered by the solar generator).

The self-contained off-grid solar panel/generator system 10, in at least one embodiment, is utilized as a single stand-alone, self-contained solar panel. In this embodiment, any other solar or other system components are contained within the same, single solar panel housing.

The self-contained off-grid solar panel/generator system 10 is useful in locations where traditional power sources are not available or reliable, such as campsites, worksites, picnic sites, county or state fairgrounds, craft shows, festivals, the desert, parks, athletic events, parking lots, and the like. At locations wherein contact with the traditional power grid exists and is perhaps practical, the self-contained off-grid solar panel/generator system 10 provides an alternative power source such that no drain on the traditional power grid occurs.

In various embodiments, the self-contained off-grid solar panel/generator system 10 is configured for outdoor kitchens, workshops, picnic areas, and the like. Even in locations where traditional power sources are available, users can utilize the self-contained solar generator 10 to capture sunlight and power devices without the need to draw upon the traditional power grid or utilizes such energy resources.

The self-contained off-grid solar panel/generator system 10 is configured for personal use. However, in various embodiments, the system 10 can be used with components configured for collecting and creating a higher power (more solar panels, utilization of battery banks rather than a single battery, use of a combiner, and so forth) and used for commercial or larger power uses. The self-contained off-grid solar panel/generator system 10 can be manufactured in various versions dependent upon the application and power needs for the end-user. By way of example, a small unit may be most suitable for a single user having only a few low power devices. Larger units are configured for devices requiring more power and/or requiring more power for longer periods of time.

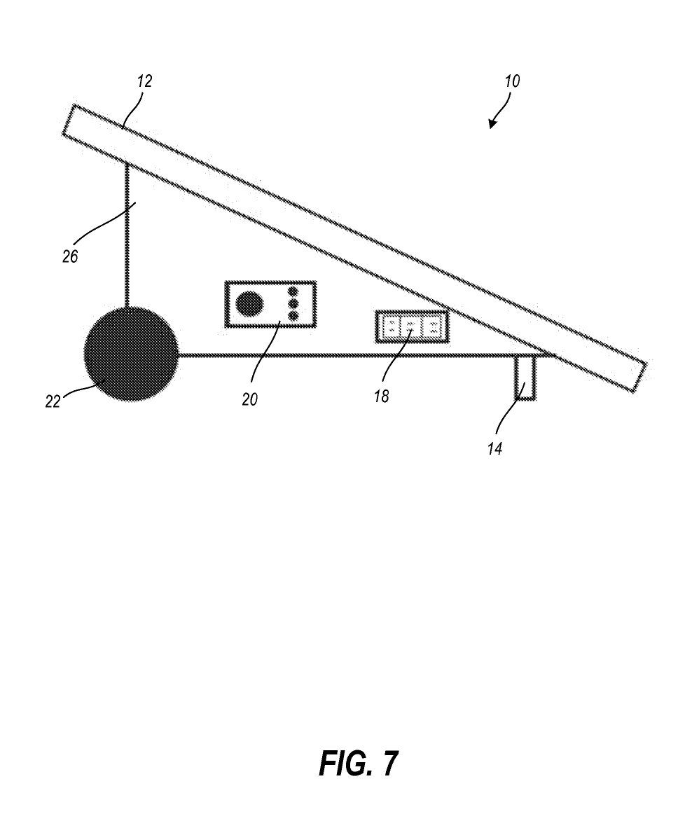

In one exemplary embodiment, the portable self-contained off-grid solar panel/generator system 10 is configured for utilization in a side-standing position, such as, for example, but not of limitation, at a sixty-five degree angle relative to the ground. By way of example, a side-standing position for the system 10 is depicted in FIG. 7. As depicted, the system 10 is at rest in this upright or side-standing position and requires no user intervention to maintain the system 10 in the position. The angle can be varied in original equipment manufacture, or the system 10, in an alternative embodiment, can be adjusted by a user to change the angle as desired based on location, angle to the sun, and other relevant factors. Additionally, in the side-standing position (FIG. 7) the system 10 can be rotated to seek the best direction toward the rays of the sun.

In one exemplary embodiment, the portable self-contained off-grid solar panel/generator system 10 is configured for utilization in a prone position, such as, for example, but not of limitation, at a twenty degree angle relative to the ground. By way of example, a prone position for the system 10 is depicted in FIG. 8. As depicted, the system 10 is at rest in this upright or side-standing position and requires no user intervention to maintain the system 10 in the position. The angle can be varied in original equipment manufacture, or the system 10, in an alternative embodiment, can be adjusted to change the angle. Additionally, in the prone position (FIG. 8) the system 10 can be rotated to seek the best direction toward the rays of the sun.

The portable self-contained off-grid solar panel/generator system 10 is easily moved from a side standing position (FIG. 7) to a prone position (FIG. 8), or vice versa, by grasping handle 14 and lifting or lowering the system 10 by the operator. The system 10 is easily rotated toward the sun from either position and is easily switched between positions.

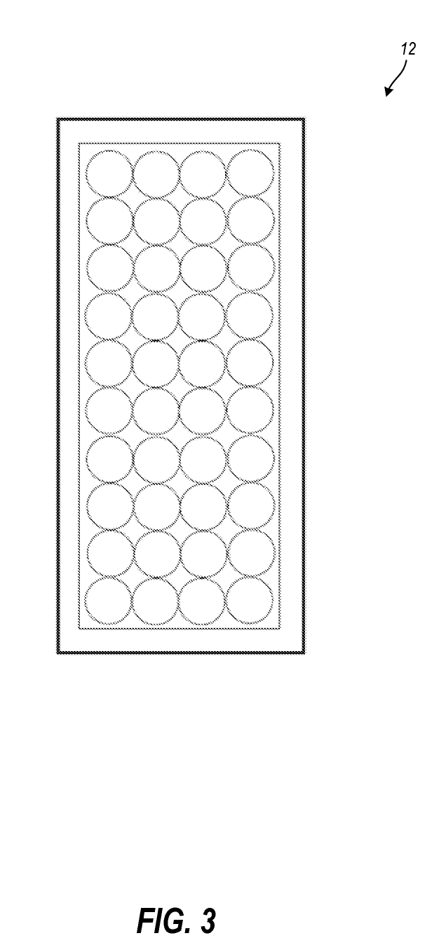

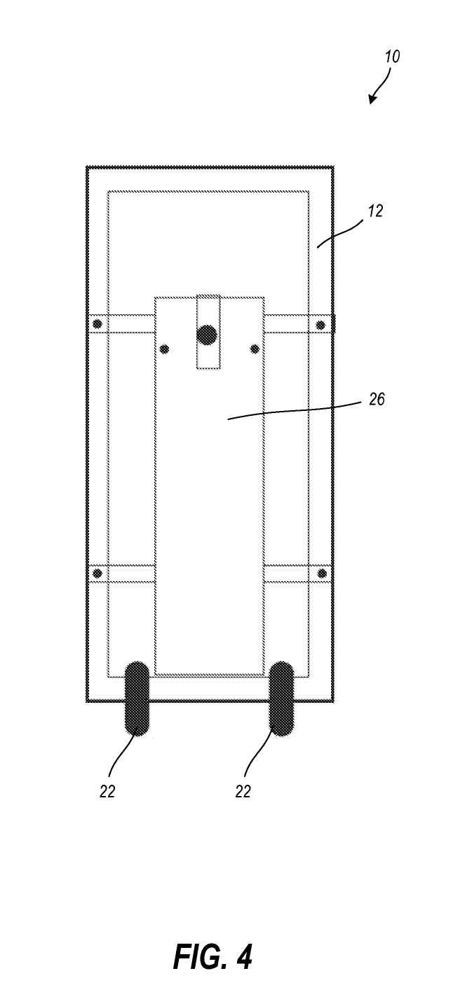

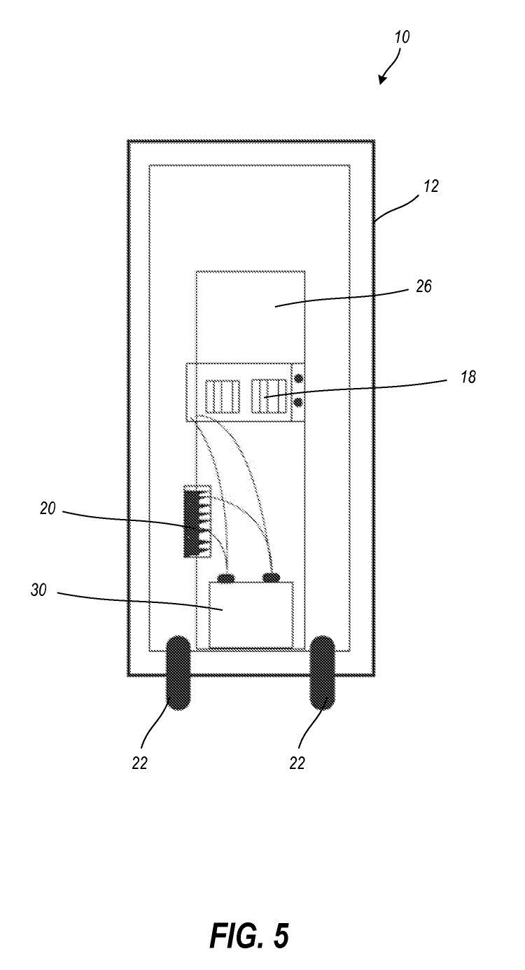

In one exemplary embodiment, the self-contained off-grid solar panel/generator system 10 includes a solar panel assembly 12. The solar panel assembly 12 can include one or more solar panels 12 in a solar array. By way of example, a solar panel assembly 12 is specifically depicted in FIG. 3, as well as noted in most other Figures. When multiple solar panels 12 are utilized, a combiner can be used to combine the collected solar power.

The arrangement, number, and type of the solar panels 12 can vary based on power needs of the device they are to power and other manufacturing and use considerations. Additionally, the number and placement of the solar panels 12 in the solar panel array can be varied in order to optimize the capture of sunlight.

In one exemplary embodiment, the portable self-contained off-grid solar panel/generator system 10 includes a housing 26. Within the housing 26, various solar components and other items are stored. The housing 26 can include a door 32, or opening to the internal area of the housing 26 for storage access. The door 32 can be accessed by a door latch 16. The door latch 16 can be secured, such as using a lock, or being a lock in and of itself in at least one embodiment.

The portable self-contained off-grid solar panel/generator system 10 is configured for ease of use both in transport and in set-up. In one exemplary embodiment, the portable self-contained off-grid solar panel/generator system 10 includes one or more wheels 22 upon which the system 10 is rolled like a cart. As depicted in the Figures, the system 10 includes two wheels 22; however, the number and location of any one or more wheel 22 can vary based on application, use, and transport needs by the end-user.

In at least one embodiment, the portable self-contained off-grid solar panel/generator system 10 includes one or more handles 14. The handles 14 also provide a user with ease of use in transport and set-up of the portable self-contained solar generator system 10. The handles 14 can be further configured with grips.

In at least one embodiment, the portable self-contained off-grid solar panel/generator system 10 also includes legs 28 disposed upon the housing. The legs 28 provide a base or rest to the system 10 while it is stationary. In this embodiment, the system 10 loosely resembles a wheel cart or wheel barrow in which the wheel 22 or wheels 22 are in the front of the system 10 and in which when the system 10 is at rest, it is supported by the legs 28.

In one exemplary embodiment, the portable self-contained off-grid solar panel/generator system 10 includes a battery 30 or a bank of batteries. The battery 30 or a bank of batteries is configured to store power for supplying power to the tool, electric cooking device, or like device, that is the load. The battery 30 or the bank of batteries is rechargeable.

In one exemplary embodiment, the portable self-contained off-grid solar panel/generator system 10 includes an inverter 18. The inverter 18 is disposed with the housing 26, but has accessible inputs/outputs such that they are accessible by a user at the outside surface of the housing 26 to the system 10. The inverter 18 is configured to convert the DC power from the battery 30 or battery bank into AC power for a machine that is also configured to utilize AC power such as a tool or electric cooking device, or the like.

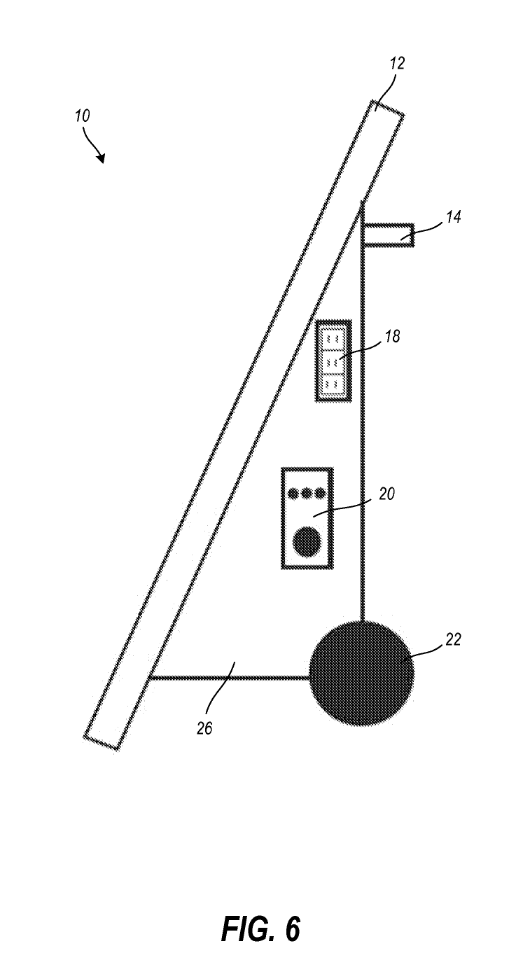

In one exemplary embodiment, the portable self-contained off-grid solar panel/generator system 10 includes a charge controller 20. The charge controller 20 regulates the charge of the battery 30 or bank of batteries from power collected by the solar panel 12 or panels from sunlight 24 (solar rays), as depicted in FIG. 6.

In various embodiments, the self-contained off-grid solar panel/generator system 10 can also include or more of the following: wiring harnesses, combiners, converters, DC disconnects, grid tie converters, traditional power options, and so forth. In an embodiment having a grid tie converters, the system 10 can return power to the traditional power source.

In at least one embodiment, the self-contained off-grid solar panel/generator system 10 also includes a combiner to combine the multiple inputs from the multiple solar panels 12 in the solar panel array in embodiments in which multiple solar panel arrays are utilized.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A self-contained solar panel assembly comprising:
a panel housing of the self-contained solar panel;
at least one photovoltaic panel disposed upon, or integrally formed with, the housing, wherein the at least one photovoltaic panel comprises at least one wall of the housing; and
at least one rechargeable battery disposed within the panel housing and adapted to store power for supplying power, once charged by the at least one photovoltaic panel, to a device;
wherein the at least one photovoltaic panel and the at least one rechargeable battery are both contained within, or integrally formed with, the panel housing.

2. The self-contained solar panel assembly of claim 1, further comprising:
an inverter disposed within the housing, yet having a plurality of inputs and outputs such that they are accessible by a user at the outside surface of the housing, and adapted to convert the DC power from the at least one rechargeable battery into AC power for a machine also configured to utilize AC power;
wherein the at least one photovoltaic panel, the at least one rechargeable battery, and the inverter are all contained within, or integrally formed with, the panel housing.

3. The self-contained solar panel assembly of claim 1, further comprising:
a charge controller, disposed within the housing and adapted to regulate a charge of the at least one rechargeable battery from power collected by the at least one photovoltaic panel from sunlight;
wherein the at least one photovoltaic panel, the at least one rechargeable battery, and the charge controller are all contained within, or integrally formed with, the panel housing.

4. The self-contained solar panel assembly of claim 1, further comprising:
a plurality of photovoltaic panels disposed upon, or integrally formed with, the housing; and
a combiner adapted to combine collected solar power from the plurality of photovoltaic panels;
wherein the plurality of photovoltaic panels, the at least one rechargeable battery, and the combiner are all contained within, or integrally formed with, the panel housing.

5. The self-contained solar panel assembly of claim 1, wherein the self-contained solar panel assembly is adapted for use as a single stand-alone, self-contained solar panel, and wherein any other system components utilized in the solar panel are contained within the same solar panel housing.

6. The self-contained solar panel assembly of claim 1, wherein the self-contained solar panel assembly is adapted for utilization in a side-standing position at a pre-determined angle relative to the ground.

7. The self-contained solar panel assembly of claim 6, wherein the pre-determined angle is approximately sixty-five degrees relative to the ground.

8. The self-contained solar panel assembly of claim 1, wherein the self-contained solar panel assembly is adapted for utilization in a prone position at a pre-determined angle relative to the ground.

9. The self-contained solar panel assembly of claim 8, wherein the pre-determined angle is approximately twenty degrees relative to the ground.

10. The self-contained solar panel assembly of claim 1, wherein the self-contained solar panel assembly is adapted for utilization in a side-standing position at a pre-determined angle relative to the ground, and interchangeably in a prone position at a pre-determined angle relative to the ground.

11. The self-contained solar panel assembly of claim 1, further comprising:
at least one handle disposed upon the panel housing and adapted for grasp by a user to change an angle at which the solar panel operates.

12. The self-contained solar panel assembly of claim 1, further comprising:
a door disposed upon the panel housing and adapted to provide an opening to within the housing for storage of one or more solar components.

13. A portable, self-contained, off-grid solar panel/generator cart comprising:
a housing;
at least one photovoltaic panel disposed upon, or integrally formed with, the housing, wherein the at least one photovoltaic panel forms at least one wall of the housing;
at least one rechargeable battery disposed within the housing and adapted to store power for supplying power, once charged by the at least one photovoltaic panel, to a device; and
at least one wheel disposed upon the housing and upon which the solar panel/generator cart is rolled like a cart.

14. The portable, self-contained, off-grid solar panel/generator cart of claim 13, further comprising:
an inverter disposed within the housing, yet having a plurality of inputs and outputs such that they are accessible by a user at the outside surface of the housing, and adapted to convert the DC power from the at least one rechargeable battery into AC power for a machine also configured to utilize AC power;

15. The portable, self-contained, off-grid solar panel/generator cart of claim 13, further comprising:
a charge controller, disposed within the housing and adapted to regulate a charge of the at least one rechargeable battery from power collected by the at least one photovoltaic panel from sunlight;

16. The portable, self-contained, off-grid solar panel/generator cart of claim 13, wherein the portable, self-contained, off-grid solar panel/generator cart is adapted for utilization in a side-standing position at a pre-determined angle relative to the ground, and interchangeably in a prone position at a pre-determined angle relative to the ground.

17. The portable, self-contained, off-grid solar panel/generator cart of claim 13, further comprising:
at least one handle disposed upon the panel housing and adapted for grasp by a user to change an angle at which the solar panel operates.

18. The portable, self-contained, off-grid solar panel/generator cart of claim 13, further comprising:
a door disposed upon the panel housing and adapted to provide an opening to within the housing for storage of one or more solar components.

19. A self-contained solar panel comprising:
a panel housing of the self-contained solar panel;
a plurality of photovoltaic panels disposed upon, or integrally formed with, the housing;
at least one rechargeable battery disposed within the panel housing and adapted to store power for supplying power, once charged by plurality of photovoltaic panels, to a device;
an inverter disposed within the housing, yet having a plurality of inputs and outputs such that they are accessible by a user at the outside surface of the housing, and adapted to convert the DC power from the at least one rechargeable battery into AC power for a machine also configured to utilize AC power;
a charge controller, disposed within the housing and adapted to regulate a charge of the at least one rechargeable battery from power collected by the plurality of photovoltaic panels from sunlight;
a combiner adapted to combine collected solar power from the plurality of photovoltaic panels;
wherein the plurality of photovoltaic panels, the at least one rechargeable battery, the inverter, the charge controller, and the combiner are all contained within, or integrally formed with, the panel housing.

20. The self-contained solar panel comprising of claim 19, further comprising:
at least one handle disposed upon the panel housing and adapted for grasp by a user to change an angle at which the solar panel operates; and
a door disposed upon the panel housing and adapted to provide an opening to within the housing for storage of one or more solar components;
wherein the self-contained solar panel is adapted for utilization in a side-standing position at a pre-determined angle relative to the ground, and interchangeably in a prone position at a pre-determined angle relative to the ground.
